(19) United States
(12) Patent Application Publication
(10) Pub. No.: US 2008/0219520 A1
(43) Pub. Date: Sep. 11, 2008

(54) SENSOR MONITORING

(75) Inventor: Jean-Francois Mainguet, Grenoble (FR)

Correspondence Address: FISH & RICHARDSON P.C., PO BOX 1022, MINNEAPOLIS, MN, 55440-1022, US

(73) Assignee: ATMEL CORPORATION, Fribourg (CH)

(21) Appl. No.: 11/682,514

(22) Filed: Mar. 6, 2007

(51) Int. Cl. G06K 9/03; G01D 18/00

(52) U.S. Cl. 382/124; 702/104; 702/116

(57) ABSTRACT

State data in a sensor device is generated based on data that defines sensor operating states. The state data is monitored to determine if the sensor device is operating in a predetermined operating state.

### BACKGROUND

This disclosure relates to sensor devices.

Sensor devices can include sensor manufactures that can transduce one form of energy into another, e.g., charged coupled devices, piezoelectric materials, or pyroelectric materials. Such sensor devices can also include control circuitry (e.g., amplifiers, analog-to-digital converters, input/output circuitry, etc.) on device (e.g., on-chip). The control circuitry can also include registers to store data defining operational states of the sensor, e.g., fast frame rate, slow frame rate, data encoding, etc.

The data output by the sensor device can be processed by a processing device in communication with the sensor device. The processing device can, for example, process the data received from the sensor device to reconstruct a fingerprint image and attempt to authenticate or identify the fingerprint. The processing device may also process the received data for error detection and/or correction. For example, the sensor device may be able to facilitate error processing by encoding the received data, e.g., including parity bits. Depending on the particular error process, the data can be corrected or can be ignored.

Such data errors can, for example, be caused by electrostatic discharge (ESD) events, or by some other error event. It is possible, however, for an ESD event, or some other error event, to also alter an operational state of the sensor device. For example, an error event may corrupt data in an on-chip control register so that the sensor device is operating in an unexpected or undefined state, e.g., a meta-stable state. Such errors, however, may not be readily detected in a system incorporating the sensor device. For example, a sensor device with corrupted data in a control register may appear to the processing device to be functioning properly when, in fact, the sensor device is functioning erroneously, e.g., operating at an aliasing frame rate, or incorrectly processing sensed data but error coding the data correctly, etc. Because the erroneous operating state of the sensor may not be readily detected, corrective actions, e.g., a sensor reset, can be delayed, or may not occur.

### SUMMARY

Disclosed herein are sensor monitoring systems and methods to facilitate the detection of a sensor device operational error. In one example implementation, state data can be generated in a sensor device based on data defining predetermined operating states. The state data can be monitored to determine if the sensor device is operating in a predetermined operating state. If the sensor device is determined not to be operating in the predetermined operating state, the sensor device can be commanded to revert to a predetermined operating state.

In another example implementation, a sensor system includes a sensor manufacture, a data store, and a data store monitor. The sensor manufacture can be configured to sense an external stimulus. The data store can be configured to store program data that defines sensor operating states. The data store monitor can be in communication with the data store and can be configured to generate a program data value based on the stored program data. The program data value can be used to determine if the sensor system is operating in a predetermined operating state.

In another example implementation, a sensor system includes a sensor manufacture, a processing circuit, and a sensor monitor. The sensor manufacture can be configured to sense an external stimulus, and a portion of the sensor manufacture can be insulated from the external stimulus. The processing circuit can be configured to receive a signal generated by the sensor manufacture in response to the external stimulus and configured to generate corresponding data signals. The sensor monitor can be in communication with the sensor manufacture and configured to generate a data value based on the data signal generated by the portion of the sensor manufacture insulated from the external stimulus. The data value can be used to determine if the sensor system is operating in a predetermined operating state.

### BRIEF DESCRIPTION OF THE DRAWINGS

FIG. 1 is a block diagram of an example sensor device.

FIG. 2 is a block diagram of an example sensor data store monitor.

FIG. 3 is a block diagram of another example sensor device.

FIG. 4 is a block diagram of another example sensor device.

FIG. 5 is a block diagram of another example sensor device.

FIG. 6 is a flow diagram of an example process for monitoring a sensor.

FIG. 7 is a flow diagram of an example process for generating state data.

FIG. 8 is a flow diagram of another example process for monitoring a sensor.

FIG. 9 is a flow diagram of another example process for monitoring a sensor.

### DETAILED DESCRIPTION

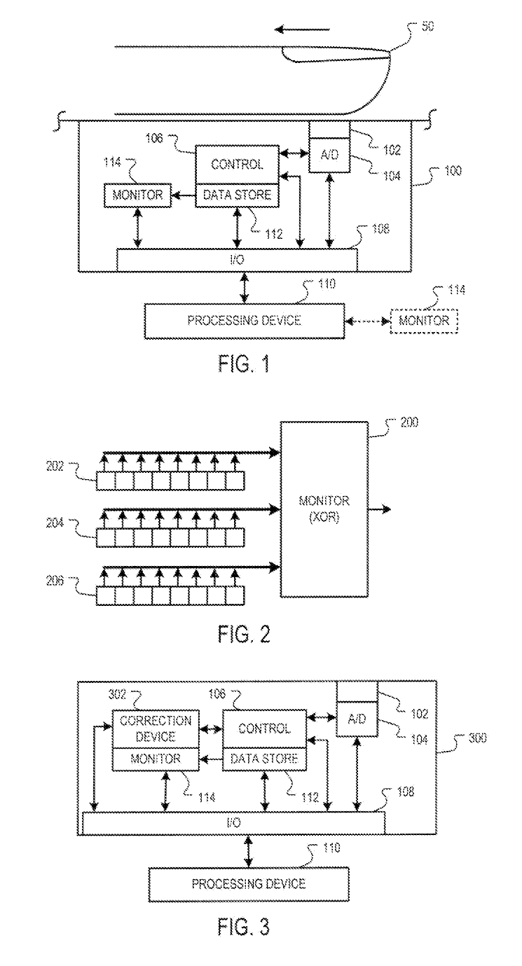

FIG. 1 is a block diagram of an example sensor device 100. The example sensor device 100 can be a biometric sensor device configured to sense a biometric stimulus, such as the swiping of a finger 50 to read a corresponding fingerprint, for example. The sensor device 100 can implement a different type of sensor, however.

The sensor device 100 can include a sensor manufacture 102 that is configured to generate electrical signals in response to, for example, a physical stimulus. For example, as the finger 50 is pressed and swiped on the sensor manufacture 102, the sensor manufacture 102 generates electrical signals based on a characteristic of the fingerprint on the finger 50. The source material of the sensor manufacture 102 can, for example, comprise a layer of polyvinylidene fluoride (PVDF), polyvinylidene fluoride, trifluoroethylene (PVDF-TrFE), polyvinylidene cyanide—vinyl acetate (PVDCN-VAc), or some other transducing material that can produce an electric charge in response to a physical stimulus, such as biometric stimulus.

The example sensor device 100 can, for example, generate multiple instances of biometric data per second, with each instance corresponding to a partial image of a fingerprint. The multiple instances of biometric data can be processed by the processing device 110 to detect overlapping data and generate a complete image of the fingerprint of the finger 50.

In another implementation, the sensor manufacture 102 can be of such proportion to receive an entire fingerprint of the finger 50. In this implementation, the finger 50 can be held stationary against the sensor manufacture 102 and an image of the entire fingerprint can be generated from a single instance of biometric data. Other biometric data collection techniques can also be used.

The electric signals output by the sensor manufacture 102 can be processed by an analog to digital converter 104, which outputs corresponding digital data. The digital data are received by a control circuit 106, which can, for example, perform additional processing, such as encoding and/or encrypting the digital data, and/or buffering the digital data. Other processing can also be performed.

The control circuit 106 is coupled to an input/output communication circuit 108, which, in turn, can be coupled to the processing device 110, such as a computer or some other processing device, e.g., a personal digital assistant, a mobile communication device, a cell phone, or some other device. The processing device 110 can be configured to receive the biometric data output by the input/output circuit 108 and perform error detection and/or correction, authentication and/or identification, or other processing algorithms.

The sensor device 100 can also include a data store 112 that can, for example, store data defining operational states of the sensor device 100. For example, the data store 112 can store data that causes the sensor device 100 to process and/or output biometric data at a particular frame rate, and/or encode the biometric data according to an encoding parameter, and/or output certain portions of the biometric data, such a particular pixel data. Other operational states can also be defined by the data stored in the data store 112. In one implementation, the data store 112 can include one or more memory registers that are configured to store program data. Other memory devices can also be used.

In one implementation, the data stored in the data store 112 comprises dynamic data that that can be changed for each state, e.g., program register bits that can be changed to place the sensor device 100 in a fast frame rate mode. In another implementation, the data stored in the data store 112 comprises static data that is fixed, e.g., the sensor device 100 has only one predefined or predetermined operating state.

The sensor device 100 can also include a monitor 114 that is in communication with the data store 114. The monitor circuit 114 can be configured to generate a program data value based on the data stored in the data store 112. The program data value can, for example, be representative of the operating state of the sensor device 100. In one example implementation, the program data value can comprise a checksum based on data stored in the data store 112. For example, the monitor circuit 114 can be configured to generate a checksum based on the data stored in a data store 112 that include 16 registers, and in which each register stores 16 bits. Other program data values can also be generated, e.g., a program data value can be based on an exclusive OR of data stored in the data store; or any other type of data value that can be used to indicate data integrity, such as a cyclic redundancy check, a horizontal redundancy check, a vertical redundancy check, a digest, or some other data value or data structure.

In one implementation, the sensor device 100 can be configured to operate in one or more predefined operating states. Example predefined operating states can include operating states for particular frame rates and operating states for particular encryption encoding states. Other predefined operating states can also be defined.

In an implementation, the data to be stored in the data store 112 for each predefined operating state can be coded to generate a common program data value for all predefined operating states, and the processing device 110 can, for example, determine whether the sensor device 100 is operating in a predefined operating state by comparing the program data value received from the monitor circuit 114 to a reference program data value. For example, if the sensor device 100 has eight predefined operating states, the program data value generated based on the data stored in the data store 112 for each predefined operating state can be the same, e.g., an eight bit value of 11110000, or some other data value. The processing device 110 can, for example, request the program data value from the monitor circuit 114, or the monitoring circuit 114 can provide the program data value to the processing device 110 periodically, e.g., with every biometric data packet. If the program data value received from the monitor circuit 114 does not match a program data reference value, e.g., 11110000, then the processing device 110 can determine that the sensor device 100 is not operating in a predefined operating state.

In another implementation, the program data can be coded so that program data values can be generated for several predefined operating states. For example, if the sensor device 100 has four predefined operating states, the program data values generated from the program data for the four predefined operating states can comprise 00000011 for two of the predefined operating states, and 11000000 for the other two predefined operating states. The processing device 110 can, for example, request the program data value from the monitor circuit 114, or the monitoring circuit 114 can provide the program data value to the processing device 110 periodically, e.g., with every biometric data packet. In one implementation, if the program data value received from the monitor circuit 114 does not match any of a set of program data reference values, e.g., 00000011 and 11000000, then the processing device 110 can determine that the sensor device 100 is not operating in a predefined operating state.

In another implementation, the program data can be coded so that a unique program data value can be generated for each predefined operating state. For example, if the sensor device 100 has four predefined operating states, the program data values generated from the program data for the four predefined operating states can comprise 00000011, 00001100, 00110000 and 11000000, or some other set of unique program data values. The processing device 110 can, for example, request the program data value from the monitor circuit 114, or the monitoring circuit 114 can provide the program data value to the processing device 110 periodically, e.g., with every biometric data packet. In one implementation, if the program data value received from the monitor circuit 114 does not match any of a set of program data reference values, e.g., 00000011, 00001100, 00110000 and 11000000, or does not match an expected program data reference value, e.g., 00000011, then the processing device 110 can determine that the sensor device 100 is not operating in a predefined operating state.

The processing device 110 can, for example, be further configured to cause the sensor device 100 to revert to a predefined operating state if the processing device 110 determines, based on the program data value, that the sensor device 100 is not operating in a predefined operating state. For example, the processing device 110 can cause the sensor device 100 to reset by issuing a reset command. In another implementation, the processing device 110 can program the sensor device 100 to a predefined operating state by loading program data into the data store 112. Other processes to set the sensor device 100 to a predefined operating state can also be used.

In the implementation of FIG. 1, the monitoring circuit 114 can be located on-device (e.g., on-chip or on the same substrate as the sensor manufacture 102), and the processing device 110, by executing a corresponding correction algorithm, can serve as a correcting device. In one implementation, the processing device 110 can also execute an algorithm to perform the functions of the monitoring circuit 114 described above, or the monitoring circuit 114 can be located off-device, as indicated by the phantom monitoring circuit 114. Data stored in the data store 112 can be provided to the processing device 110 and/or the off-device monitoring circuit 114 for determining whether the sensor device 110 is operating in a predefined state.

In another implementation, the monitoring circuit 114 and the input/output circuit 108 can, for example, be configured to place the sensor manufacture 102 output terminals in a high impedance state upon the monitoring circuit 114 generating a program data value indicating that the sensor device 100 is not operating in a predefined operating state. For example, if the monitor circuit 114 generates a program data value corresponding to one or more predefined operating states, the output connections of the input/output circuit 108 can be placed in a high impedance state to preclude further transmission of erroneous data to the processing device 110. In one example implementation, the output terminals of the input/output circuit 108 can be coupled to the processing device 110 through a switch matrix. The switch matrix can be controlled by a logic circuit programmed to open the switch matrix when the monitoring circuit 114 generates a program data value indicating that the sensor device 100 is not operating in a predefined operating state. Other processes to preclude further transmission of erroneous data can also be used.

In another implementation, the processing device 110 can, for example, be configured to cause the sensor device 100 to enter a lockout state if a number of determinations that the sensor device 100 is not operating in a predetermined operating state over a time period exceeds a threshold. This implementation can, for example, provide added security in such cases as the sensor device 100 being compromised, or if an unauthorized sensor device emulator is attached to the processing device 110. In one implementation, the lockout can be of a fixed duration, e.g., one hour. Other durations can also be used.

FIG. 2 is a block diagram of an example data stored monitor 200. The example monitor 200 can, for example, be used to implement the data store monitor circuit 114 of FIG. 1. The data store monitor 200 can be in communication with data stores 200, 202 and 204 of an example sensor device. The data stores 200, 202 and 204 can, for example, store dynamic program data or static program data. The data store monitor 200 can, for example, generate a checksum based on an exclusive or program data stored in the data stores 200, 202 and 204. The checksum can be used as the program data value. Other program data values can also be generated based on different operations, such as a cyclic redundancy check, a horizontal redundancy check, a vertical redundancy check, a digest, or some other data value.

FIG. 3 is a block diagram of another example sensor device 300. The example sensor device 300 is of similar construction and operation to the example sensor device 100, except that the example sensor device 300 includes a correction device 302 on-device (e.g., on-chip and on the same substrate as the sensor manufacture 102). The correction device 302 can, for example, perform some or all of the respective corrective functions of the processing device 110 of FIG. 1.

In one implementation, the sensor device 300 can be configured to operate in one or more predefined operating states. Example predefined operating states can include operating states for particular frame rates and operating states for particular encryption encoding states. Other predefined operating states can also be defined.

In an implementation, the data to be stored in the data store 112 for each predefined operating state can be coded to generate a common program data value for all predefined operating states, and the correction device 302 can, for example, determine whether the sensor device 300 is operating in a predefined operating state by comparing the program data value received from the monitor circuit 114 to a reference program data value. For example, if the sensor device 300 has eight predefined operating states, the program data value generated based on the data stored in the data store 112 for each predefined operating state can be the same, e.g., an eight bit value of 11110000, or some other data value. The correction device 302 can, for example, request the program data value from the monitor circuit 114, or the monitoring circuit 114 can provide the program data value to the correction device 302 periodically, e.g., during the processing of every biometric data packet. If the program data value received from the monitor circuit 114 does not match a program data reference value, e.g., 11110000, then the correction device 302 can determine that the sensor device 300 is not operating in a predefined operating state.

In another implementation, program data values can be generated for several predefined operating states. For example, if the sensor device 300 has four predefined operating states, the program data values generated for the four predefined operating states can comprise 00000011 for two of the predefined operating states, and 11000000 for the other two predefined operating states. In one implementation, if the program data value provided to the correction device 302 from the monitor circuit 114 does not match any of a set of program data reference values, e.g., 00000011 and 11000000, then the correction device 302 can determine that the sensor device 300 is not operating in a predefined operating state.

In another implementation, a unique program data value can be generated for each predefined operating state. For example, if the sensor device 300 has four predefined operating states, the program data values generated for the four predefined operating states can comprise 00000011, 00001100, 00110000 and 11000000, or some other set of unique program data values. In one implementation, if the program data value received provided to the correction device 302 from the monitor circuit 114 does not match any of a set of program data reference values, e.g., 00000011, 00001100, 00110000 and 11000000, or does not match an expected program data reference value, e.g., 00000011 then the correction device 302 can determine that the sensor device 300 is not operating in a predefined operating state.

The correction device 302 can, for example, be further configured to cause the sensor device 300 to revert to a predefined operating state if the correction device 302 determines, based on the program data value, that the sensor device 300 is not operating in a predefined operating state. For example, the correction device 302 can cause the sensor device 300 to reset by issuing a reset command. In another implementation, the correction device 302 can program the sensor device 300 to a predefined operating state by loading program data into the data store 112. Other processes to set the sensor device 300 to a predefined operating state can also be used.

In another implementation, the correction device 302 and the input/output circuit 108 can, for example, be configured to place the sensor device 300 output terminals in a high impedance state upon the correction device 302 determining that the sensor device 300 is not operating in a predefined operating state. In one example implementation, the output terminals of the input/output circuit 108 can be coupled to the correction device 302 through a switch matrix controlled by a logic circuit. The logic circuit can be programmed to open the switch matrix when the correction device 302 determines that the sensor device 300 is not operating in a predefined operating state. Other processes to preclude further transmission of erroneous data can also be used.

In another implementation, the correction device 302 can include an accumulator that can be used in conjunction with a timer to determine a number of occurrences that the sensor device 300 is not operating in a predetermined operating state. For example, the correction device can be configured to cause the sensor device 300 to enter a lockout state if a number of determinations that the sensor device 300 is not operating in a predetermined operating state over a time period exceeds a threshold. In one implementation, the lockout can be of a fixed duration, e.g., one hour. Other durations can also be used.

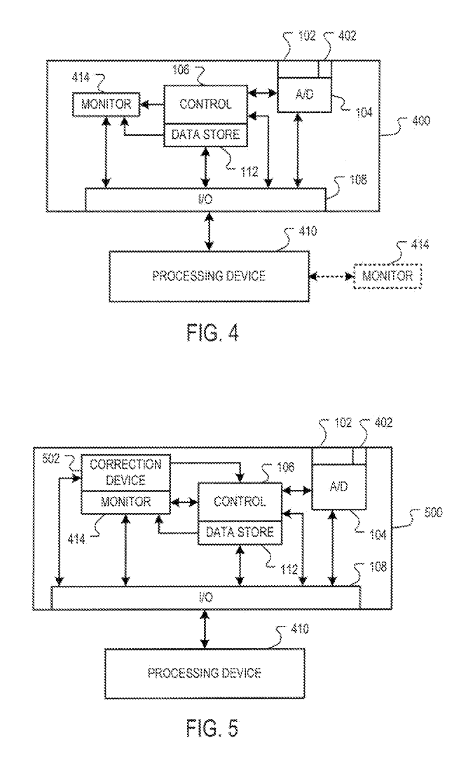

FIG. 4 is a block diagram of another example sensor device 400. The example sensor device 400 is of similar construction and operation to the example sensor device 100, except that the example sensor device 400 includes an insulated portion 402 of the sensor manufacture 102 that is insulated from an external stimulus. Because the insulation portion 402 is insulated from the external stimulus, the corresponding digital data output by the analog to digital converter 104 can, for example, comprises a known value, or a value within a tolerance window.

In one implementation, a monitor circuit 414 can, for example, generate a data value based on the data signal generated by the insulated portion 402 of the sensor manufacture 102. The processing device 410 can, for example, request the data value from the monitor circuit 414, or the monitor circuit 414 can provide the data value to the processing device 410 periodically, e.g., with every biometric data packet. If the data value received from the monitor circuit 414 does not match a data reference value or is outside of the tolerance window, then the processing device 410 can determine that the sensor device 400 is not operating in a predefined operating state.

The processing device 410 can, for example, be further configured to cause the sensor device 400 to revert to a predefined operating state if the processing device 410 determines, based on the data value, that the sensor device 400 is not operating in a predefined operating state.

In another implementation, the monitor circuit 414 can be configured to generate a data value based on the program data stored in the data store 112 and the data signal generated by the portion 402 of the sensor manufacture 102. In one implementation, the monitor circuit 414 can integrate a predetermined value into a checksum if the data signal generated by the portion 402 of the sensor manufacture 102 is within a tolerance window. The data value generated by the monitor circuit 414 can be provided to the processing circuit 410 for determination of the operating state of the sensor device 400 and initiating a corrective action, if necessary, e.g., a reset of the sensor device 400, loading program data into the data store 112, or some other corrective action.

In the implementation of FIG. 4, the monitoring circuit 414 can be located on-device (e.g., on-chip on the same substrate as the sensor manufacture 102), and the processing device 410, by executing a corresponding correction algorithm, can serve as a correcting device. In one implementation, the processing device 410 can also execute an algorithm to perform the functions of the monitoring circuit 414 described above, or the monitoring circuit 414 can be located off-chip, as indicated by the phantom monitoring circuit 414. Data stored in the data store 112 can be provided to the processing device 410 and/or the off-chip monitoring circuit 414 for determining whether the sensor device 410 is operating in a predefined state.

In another implementation, the monitoring circuit 414 and the input/output circuit can, for example, be configured to place the sensor manufacture 400 output terminals in a high impedance state upon the monitoring circuit 414 generating a data value indicating that the sensor device 400 is not operating in a predefined operating state.

In another implementation, the processing device 410 can, for example, be configured to cause the sensor device 400 to enter a lockout state if a number of determinations that the sensor device 400 is not operating in a predetermined operating state over a time period exceeds a threshold.

FIG. 5 is a block diagram of another example sensor device 500. The example sensor device 500 is of similar construction and operation to the example sensor devices 400, except that the example sensor device 500 includes a correction device 502 on-device (e.g., on-chip and on the same substrate as the sensor manufacture 102). The correction device 502 can, for example, perform some or all of the respective corrective functions of the processing device 410 of FIG. 4. Thus, if the data value generated by the monitor circuit 414 indicates that the sensor device 500 is not operating in a predefined state, then the correction device 502 can initiate a corrective action, e.g., a reset of the sensor device 500, loading program data into the data store 112, or some other corrective action.

In an implementation, the example sensor devices of FIGS. 1-5 can, for example, be configured to facilitate automatic sensor recovery or automatic resets of sensor devices. For example, the correction device and/or processing device can be configured to cause the sensor device to revert to a predetermined operating state upon detecting that the sensor device is operating in an unknown state, e.g., a state that is not predetermined. The reversion can, for example, occur without user intervention.

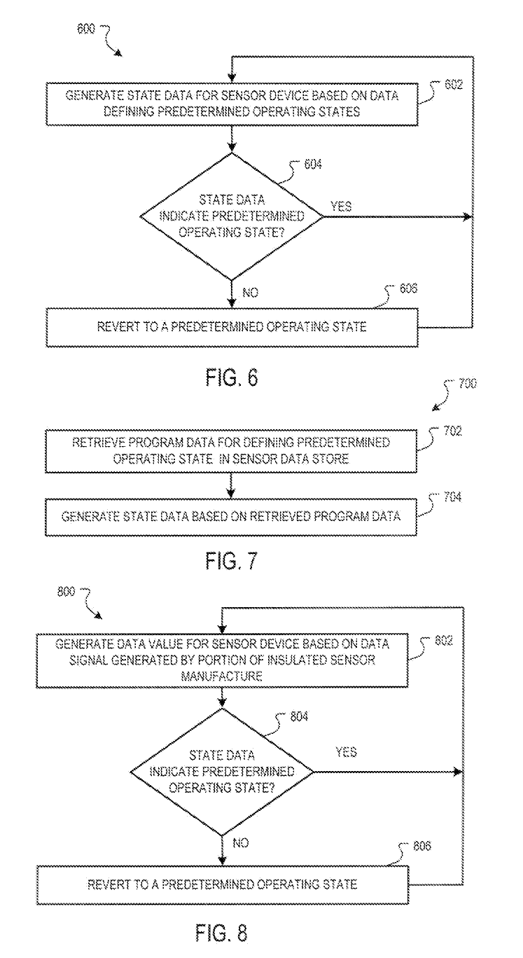

FIG. 6 is a flow diagram of an example process 600 for monitoring a sensor device. The process 600 can, for example, be implemented in the example sensor devices 100, 300, 400 and 500, or in other sensor devices.

Stage 602 generates state data for a sensor device based on data defining predetermined operating states. For example, the monitoring circuits 114, 200 and 414, or the processing devices 110 and 410, can be used to generate state data, such as a program data value, based on data stored in the data store 112.

Stage 604 determines if the state data indicates a predetermined operating state. For example, the processing devices 110 and 410, or the correction devices 302 and 502, can determine if the state data indicates a predetermined operating state by comparing the generated state data to reference state data.

If the state indicates a predetermined operating state, then the process 600 returns to stage 602. If, however, the state data indicates that the sensor device is not operating in a predetermined operating state, then state 606 reverts to a predetermined operating state. For example, the processing devices 110 and 410, or the correction devices 302 and 502, can reset the sensor device, or load program data into the data store 112, or initiate some other corrective action to cause the sensor device to revert to a predefined operating state. In another implementation, the processing devices 110 and 410, or the correction devices 302 and 502, can, for example, issue an alert to notify a user of a possible error. In yet another implementation, the processing devices 110 and 410, or the correction devices 302 and 502, can, for example, start a counter for determining whether the number of error occurrences in a given time period exceed a threshold.

FIG. 7 is a flow diagram of an example process 700 for generating state data. The process 700 can, for example, be implemented in the example sensor devices 100, 300, 400 and 500, or in other sensor devices.

Stage 702 retrieves program data for defining predetermined operating states in a sensor data store. For example, the monitoring circuits 114, 200 and 414, or the processing devices 110 and 410, can be used to retrieve program data stored in the data store 112.

Stage 704 generates state data based on retrieved program data. For example, the monitoring circuits 114, 200 and 414, or the processing devices 110 and 410, can be used to generate state data, such as a program data value, based on data stored in the data store 112. The state data can be realized by a checksum, a cyclic redundancy check, a horizontal redundancy check, a vertical redundancy check, a digest, or some other data value from which a measure of data integrity can be ascertained.

FIG. 8 is a flow diagram of another example process 800 for monitoring a sensor device. The process 800 can, for example, be implemented in the example sensor devices 400 and 500, or in other sensor devices.

Stage 802 generates the data value for a sensor device based on the data signal generated by a portion of the insulated sensor manufacture. For example, the monitor circuit 414 or the processing device 410 can be used to generate the data value based on the data signal generated by the insulated portion 402 of the sensor manufacture 102.

Stage 804 determines if the state data indicates a predetermined operating state. For example, the processing device 410 or the correction device 502 can be used to determine whether the state data indicates a predetermined operating state.

If the state data indicates a predetermined operating state, then the process 800 returns to stage 802. If, however, the state data does not indicate a predetermined operating state, then stage 806 reverts to a predetermined operating state. For example, the processing device 410 or the correction device 502 can reset the sensor device, or load program data into the data store 112, or initiate some other corrective action to cause the sensor device to revert to a predefined operating state. In another implementation, the processing device 410 or the correction device 502, can, for example, issue an alert to notify a user of a possible error. In yet another implementation, the processing device 410 or the correction device 502, can, for example, start a counter for determining whether the number of error occurrences in a give time period exceed a threshold.

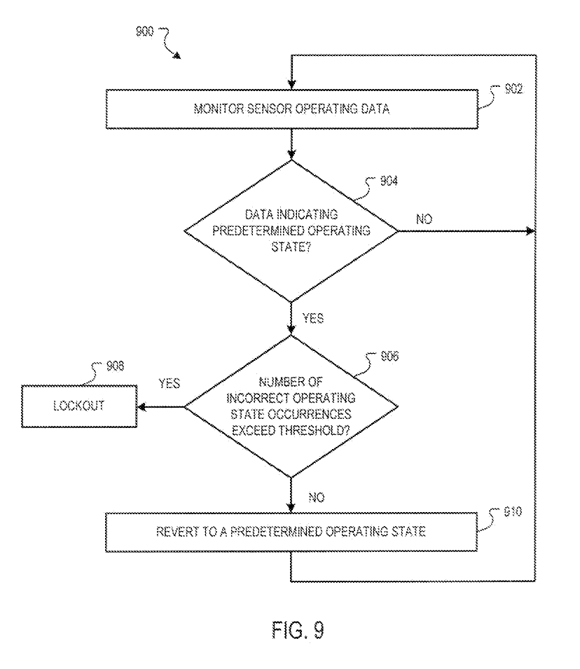

FIG. 9 is a flow diagram of another example process 900 for monitoring a sensor device. The process 900 can, for example, be implemented in the example sensor devices 100, 300, 400 and 500, or in other sensor devices.

Stage 902 monitors the sensor operating data. For example, the monitor circuits 114, 200 and 414, or the processing devices 110 and 410, can be used to generate a program data value based on the data stored in the data store 112.

Stage 904 determines if data indicates the predetermined operating state. For example, the processing devices 110 and 410, or the correction devices 302 and 502, can determine if the program data values indicate a predetermined operating state.

If the program data value indicates that the sensor device is operating in a predetermined operating state, then process 900 returns to state 902. If, however, the program data value indicates that the sensor device is not operating in a predetermined operating state, then stage 906 determines if the number of incorrect operating state occurrences over a time period exceeds the threshold. For example, the processing devices 110 and 410, or the correction devices 302 and 502 can determine the number of incorrect operating state occurrences has exceeded a threshold number of occurrences during a time period.

If the number of incorrect operating state occurrences exceeds the threshold, then stage 908 executes a correction routine. In one implementation, the correction routine can be a lockout. For example, the processing devices 110 and 410, or the correction devices 302 and 502 can cause the sensor device to lockout for a duration, e.g., one hour.

If, however, the number of incorrect operating state occurrences does not exceed the threshold, then stage 910 reverts to a predetermined operating state. For example, the processing devices 110 and 410, or the correction devices 302 and 502, can reset the sensor device, or load program data into the data store 112, or initiate some other corrective action to cause the sensor device to revert to a predefined operating state.

This written description set forth the best mode of the invention and provides examples to describe the invention and to enable a person of ordinary skill in the art to make and use the invention. This written description does not limit the invention to the precise terms set forth. Thus, while the invention has been described in detail with reference to the examples set forth above, those of ordinary skill in the art may effect alterations, modifications and variations to the examples without departing from the scope of the invention.

What is claimed is:

1. A sensor system, comprising:
a sensor manufacture configured to sense an external stimulus;
at least one data store configured to store program data that defines sensor operating states; and
a data store monitor in communication with the at least one data store and configured to generate a program data value based on the stored program data.

2. The sensor system of claim 1, comprising:
a communication circuit configured to output sensor manufacture data based on signals generated by the sensor manufacture and configured to output the program data value.

3. The sensor system of claim 2, wherein:
the sensor manufacture, the at least one data store, the data store monitor and the communication circuit are integrated in a sensor device module.

4. The sensor system of claim 3, comprising:
a correction device configured to receive the program data value transmitted from the communication circuit and to determine whether the sensor device module is operating in a predetermined operating state based on the program data value.

5. The sensor system of claim 4, wherein:
the correction device is configured to cause the at least one data store to store program data that defines a predetermined operating state in response to determining that the sensor device module is not operating in a predetermined operating state;
wherein storing the program data that defines a predetermined operating state causes the sensor device module to revert to the predetermined operating state.

6. The sensor system of claim 5, wherein:
the predetermined operating state comprises a sensor operating state selected by the correction device.

7. The sensor system of claim 4, wherein:
the correction device is configured to cause the sensor device module to enter a lockout state if the number of determinations that the sensor device module is not operating in a predetermined operating state over a time period exceeds a threshold.

8. The sensor system of any one of claims 1, 4, 6 and 7, wherein:
the program data value comprises a checksum based on the stored program data.

9. The sensor system of any one of claims 1, 4, 6 and 7, wherein:
the program data value comprises parity bits based on the stored program data.

10. The sensor system of claim 1, comprising:
a correction device in communication with the data store monitor and configured to determine whether the sensor system is operating in a predetermined operating state.

11. The sensor system of claim 10, wherein:
the correction device is configured to cause sensor system to revert to the predetermined operating state in response to determining that the sensor system is not operating in the predetermined operating state.

12. The sensor system of claim 11, wherein:
the sensor manufacture, the at least one data store, the data store monitor and the correction device are integrated in a sensor device module.

13. The sensor system of claim 12, further comprising:
a communication circuit configured to output sensor manufacture data based on signals generated by the sensor manufacture and configured to enter a high impedance output state if the correction device determines that the sensor device module is not operating in a predetermined operating state.

14. The sensor system of any one of claims 1, 6, 7 and 13, wherein:
the program data that defines sensor operating states comprises static data.

15. The sensor system any one of claims 1, 6, 7 and 13, wherein:
the program data that defines sensor operating states comprises dynamic data.

16. A sensor system, comprising:
a sensor manufacture configured to sense an external stimulus and comprising a portion of the sensor manufacture insulated from the external stimulus;
a processing circuit configured to receive a signal generated by the sensor manufacture in response to the external stimulus and configured to generate corresponding data signals; and
a sensor monitor in communication with the sensor manufacture and configured to generate a data value based on the data signal generated by the portion of the sensor manufacture insulated from the external stimulus.

17. The sensor system of claim 16, comprising:
a communication circuit configured to output sensor manufacture data based on the signal generated by the sensor manufacture and configured to output the data value.

18. The sensor system of claim 17, wherein:
the sensor manufacture, the processor circuit, the sensor monitor and the communication circuit are integrated in a sensor device module.

19. The sensor system of claim 18, comprising:
a correction device configured to receive the data value transmitted from the communication circuit and to determine whether the sensor device module is operating in a predetermined operating state based on the data value.

20. The sensor system of claim 19, wherein:
the correction device is configured to cause the sensor device module to revert to a predetermined operating state in response to determining that the sensor device module is not operating in a predetermined operating state.

21. The sensor system of claim 19, wherein:
the correction device is configured to determine that the sensor device module is operating in a predetermined operating state if the data value is within a tolerance window.

22. The sensor system of claim 16, comprising:
a correction device in communication with the sensor monitor and configured to determine whether the processing circuit is operating in a predetermined operating state based on the data value and to cause the processing circuit to revert to a predetermined operating state in response to determining that the processing circuit is not operating in a predetermined operating state.

23. The sensor system of claim 16, comprising:
at least one data store configured to store program data that defines sensor operating states; and
wherein the sensor monitor is in communication with at least one data store and configured to generate the data value based on the stored program data and the signal generated by the sensor manufacture.

24. A method, comprising:
generating state data in a sensor device based on data defining predetermined operating states;
monitoring the state data in the sensor device;
determining if the sensor device is operating in a predetermined operating state based on the state data; and
causing the sensor device to revert to a predetermined operating state if the sensor device is determined not to be operating in the predetermined operating state.

25. The method of claim 24, wherein:
generating state data in a sensor device based defining predetermined operating states comprises:
retrieving program data from at least one data store configured to store program data that defines sensor operating states; and
generating the state data from the retrieved program data.

26. The method of claim 24, wherein:
generating the state data from the retrieved program data comprises:
generating a checksum based on the retrieved program data.

27. The method of claim 24, comprising:
counting the number of occurrences of the sensor device not operating in the predetermined operating state over a time period; and
placing the sensor in a lockout state if the counted number exceeds a threshold.

28. The method of claim 24, comprising:
generating sensor output data in response to an external stimulus;
providing the sensor output data to a processing device; and
providing the state data to the processing device with the sensor output data.

29. The method of claim 24, wherein:
the state data comprises static data.

30. The method of claim 24, wherein:
the state data comprises dynamic data.

31. A sensor system, comprising:
means for generating state data in a sensor device based on data indicative of sensor operating states;
means for monitoring the state data in the sensor device;
means for determining is the sensor device is operating in a predetermined operating state based on the state data; and
means for causing the sensor device to revert to a predetermined operating state if the sensor device is determined not to be operating in a predetermined operating state.

32. A fingerprint sensor device, comprising:
a sensor manufacture configured to generate fingerprint data signals;
at least one program register configured to store program data that defines fingerprint sensor operating parameters;
a program register monitor in communication with the program register and configured to generate a program data value based on the stored program data; and
a correction device configured to receive the program data value from the program register monitor and determine whether the fingerprint sensor device is operating in a predetermined operating state based on the program data value, and further configured to cause the fingerprint sensor device to revert to a predetermined operating state in response to determining that the fingerprint sensor device is not operating in a predetermined operating state.

33. The fingerprint sensor device of claim 32, wherein:
The sensor manufacture is configured to receive a fingerprint swipe to generate the fingerprint data signals.

34. The fingerprint sensor device of claim 33, wherein:
the correction device is configured to cause the fingerprint sensor device to enter a lockout state if the number of determinations that the fingerprint sensor device is not operating in a predetermined operating state over a time period exceeds a threshold.

35. The fingerprint sensor device of claim 33, wherein:
the sensor manufacture comprises a pyroelectric material.

36. The fingerprint sensor device of claim 33, wherein:
the sensor manufacture comprises polyvinylidene fluoride.
